(19) United States
(12) Patent Application Publication
(10) Pub. No.: US 2008/0231400 A1
(43) Pub. Date: Sep. 25, 2008

(54) Low Current Switch for Motor Car Anti-Theft Lock

(75) Inventors: Louis Canard, Creteil Cedex (FR); Fabrice Giacomin, Creteil Cedex (FR)

Correspondence Address: OSHA LIANG L.L.P., 1221 MCKINNEY STREET, SUITE 2800, HOUSTON, TX, 77010, US

(73) Assignee: VALEO SECURITE HABITACLE, Creteil (unknown)

(21) Appl. No.: 12/089,860

(22) PCT Filed: Oct. 9, 2006
(86) PCT No.: PCT/EP2006/067208

§ 371 Date: Apr. 10, 2008

(30) Foreign Application Priority Data
Oct. 11, 2005 (FR) 0510348

(51) Int. Cl. H01H 9/00

(52) U.S. Cl. 335/205

(57) ABSTRACT

A switch for starting and stopping at least one operating unit of a motor vehicle configured to cooperate with an anti-theft lock having a stator and a rotor that can be rotated inside the stator and that has at least one permanent magnet secured to the rotor has at least two Reed bulbs provided with flexible leads and electrically linked by the leads to the contacts of a connector. Said Reed bulbs are arranged on a connector body designed to be fixed removably to said stator in a so-called operating position.

The invention relates to a low-current switch for a motor car anti-theft lock.

Such an anti-theft lock, particularly for starting and stopping at least one operating unit of a motor vehicle, comprises a stator and a rotor that can be rotated inside the stator, for example by means of a conventional or electronic key. It has at least one first switching element secured to the rotor and which cooperates with at least one second switching element secured to the stator.

Such a lock with low-current switch is described in the patent document U.S. Pat. No. 6,223,571.

According to this prior art document, the first switching element is a magnetic element, which can be a permanent magnet, is secured to the rotor via a cam which is itself secured to the internal end of the rotor opposite to the key entry supported by its external end. This magnet is positioned on the front side of this cam.

There are two second switching elements, which can comprise Reed bulbs. These Reed bulbs are electrically linked to a connector by their leads and are secured to the stator, arranged on a plane parallel to the front side supporting the magnet.

This type of arrangement raises the following technical problems.

A Reed bulb has an area of maximum sensitivity in the vicinity of its transverse plane of symmetry, but has zero sensitivity at the level of the connection of its leads. A relative face-to-face arrangement of the magnet and of the Reed bulb, as described in this document, induces a loss of detection at the level of its connections.

The arrangement described in this prior art document is relatively bulky, particularly in the direction of the longitudinal axis of the rotor.

Moreover, and above all, this known type of switch is totally internal to the lock and no part, apart from the connector, can be fitted or removed individually. Only the connector is independent of the lock. In the event of defection on the Reed bulbs, the entire switch must be changed, with the associated lock mechanism.

Finally, the link from the connector to the Reed bulbs via a printed circuit card and electrical cables, as described in this document, is relatively complex and costly.

The invention solves these problems and, to do this, it proposes a switch, particularly for starting and stopping at least one operating unit of a motor vehicle, designed to cooperate with an anti-theft lock comprising a stator (1) and a rotor (2) that can be rotated inside the stator and that has at least one permanent magnet (6) secured to the rotor (2), said switch comprising at least two Reed bulbs (7A, 7B) provided with flexible leads (8A, 8B) and electrically linked by their leads to the contacts (10A, 10B, 10C) of a connector, characterized in that said Reed bulbs are arranged on a connector body (4) designed to be fixed removably to said stator (1) in a so-called operating position.

According to a preferred embodiment of the invention, the longitudinal axis of said Reed bulbs is roughly parallel to the north-south axis of said magnet, in the operating position.

And, advantageously, the longitudinal axis of said Reed bulbs is roughly parallel to the longitudinal axis of the rotor, said Reed bulbs being arranged with their transverse plane of symmetry roughly in one and the same plane also containing the magnet in said operating position.

The invention ensures maximum effectiveness, through detection of the magnetic field produced in the vicinity of the transverse plane of symmetry of the Reed bulbs.

Another advantage of the invention is that it proposes a less bulky switch arrangement, and the space saved in the longitudinal direction compared to the prior art can be used to accommodate other equipment.

As a variant, the longitudinal axis of said Reed bulbs can be roughly perpendicular to the longitudinal axis of the rotor, said Reed bulbs being arranged with their longitudinal plane of symmetry roughly in one and the same plane also containing the magnet in said operating position.

According to a preferred embodiment, said Reed bulbs are directly fixed to said contacts of the connector by their leads.

Preferably, said contacts include extensions to the leads of the latter.

As a variant, said Reed bulbs can be linked to said contacts of the connector via a printed circuit card.

Said contacts can present a longitudinal axis roughly parallel to that of said Reed bulbs.

Said connector body can be fixed to the stator by a rail and slideway arrangement.

Advantageously, said rail and slideway arrangement is roughly parallel to the longitudinal axis of the rotor.

Preferably, said connector body comprises a device for snap-fitting on the stator.

The invention also relates to an anti-theft lock designed to be fitted with a switch as specified hereinabove, of which said magnet is supported by the front side of a cam secured to the internal end of the rotor.

Preferably, said magnet is made of plasto-ferrite material and is overmolded on said cam. The invention is described hereinafter in more detail with the help of figures representing just one preferred embodiment of the invention.

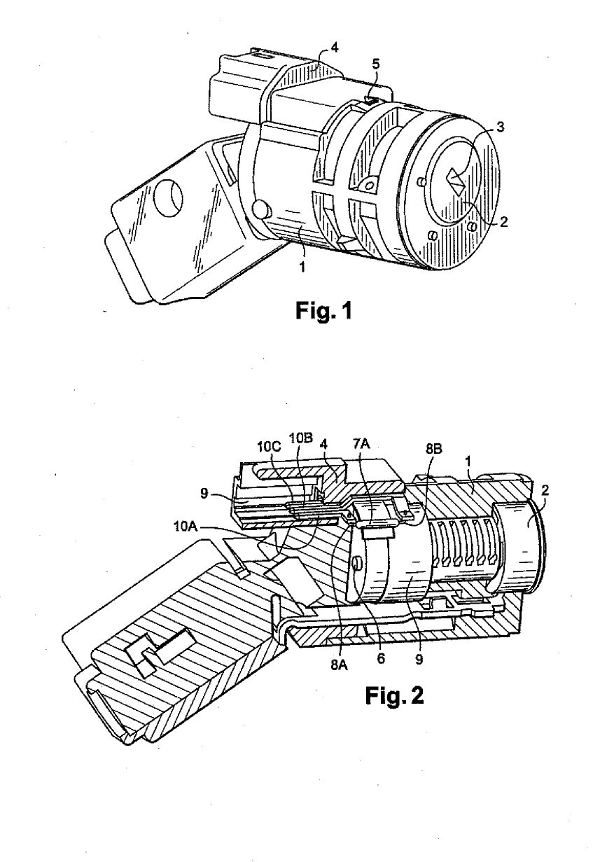

FIG. 1 is a perspective view of a switch according to the invention, fitted in an anti-theft lock.

FIG. 2 is a perspective view with partial cross-section of a switch according to the invention, fitted in an anti-theft lock.

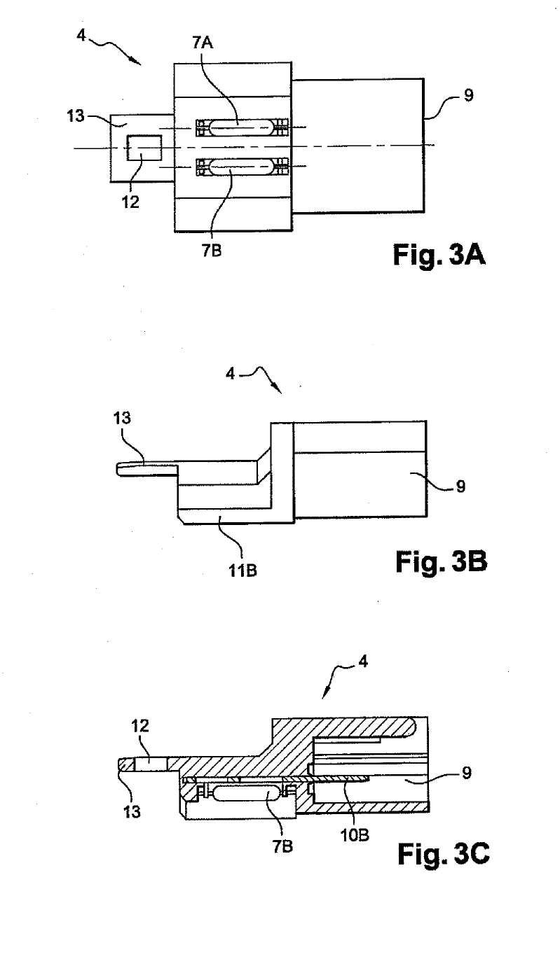

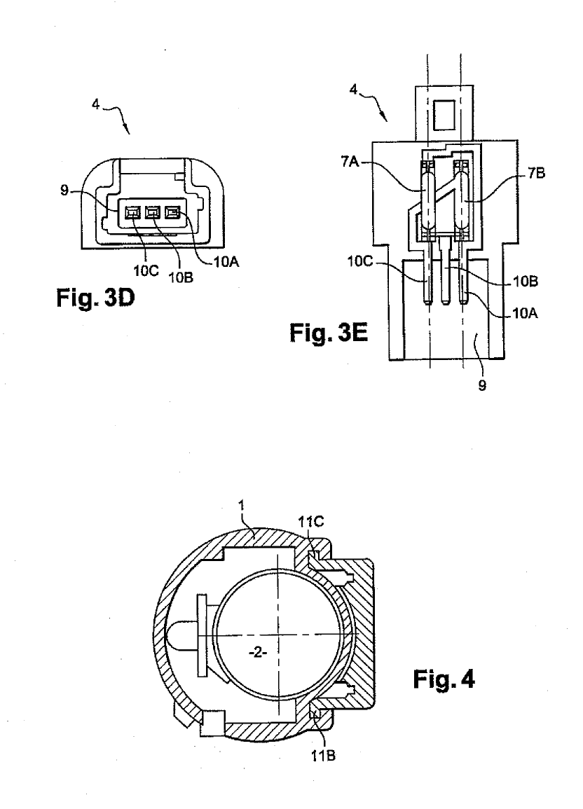

FIGS. 3A to 3E are partial views of a switch according to the invention, respectively from below, the front, in vertical longitudinal cross-section, from the side and in horizontal longitudinal cross-section.

FIG. 4 is a transverse cross-sectional view of a switch according to the invention, fitted in an anti-theft lock.

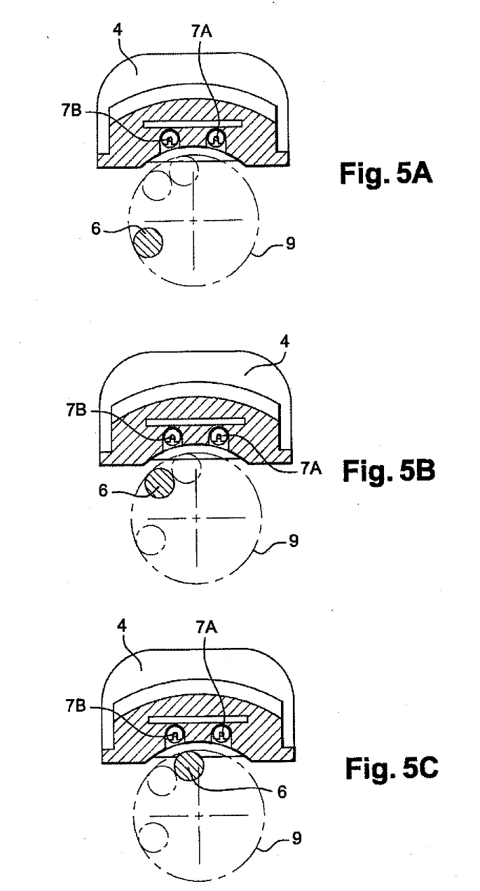

FIGS. 5A to 5C illustrate the operation of a switch according to the invention.

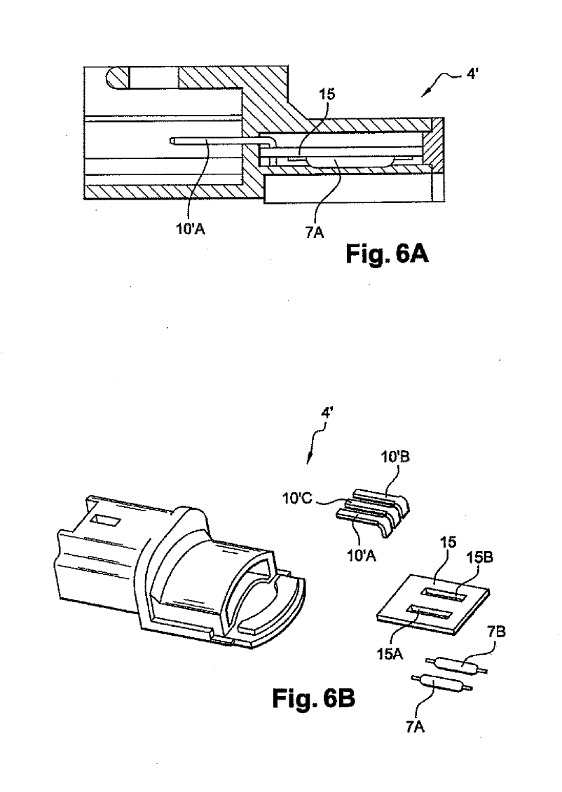

FIGS. 6A and 6B are longitudinal cross-sectional and exploded perspective views of an embodiment variant of the invention.

As can be seen in FIG. 1, an anti-theft lock, particularly for starting and stopping at least one operating unit of a motor vehicle, comprises a stator 1 and a rotor 2 that can be rotated inside the stator, for example by means of a key inserted into a key entry 3 positioned at the external end of the rotor 2.

A connector body 4 is fixed removably in the operating position on the stator 1 and comprises, at its end opposite to the contacts, a device 5 for snap-fitting on the stator, comprising an orifice snap-fitting onto an elastic tab arranged on the stator.

The construction of the connector body is particularly visible in FIGS. 2 and 3.

The switch has a permanent magnet 6 secured to the rotor and which cooperates with at least two Reed bulbs 7A, 7B provided with flexible leads 8A, 8B. The magnet 6 is supported by the front side of a cam 9 secured to the internal end of the rotor 2.

This magnet can be made of ferrite or of neodymium/iron/boron or other alloy and be fitted in a cavity provided in the cam. Advantageously, it can also be made of plasto-ferrite material and be overmolded on this cam. If necessary, the cam can be made of plasto-ferrite and the magnet formed by local polarization.

The Reed bulbs are secured to the stator 2 via the connector body 4 and are electrically linked by their leads to the contacts of a connector 9. The Reed bulbs 8A, 8B are positioned on the connector body, with their longitudinal axis roughly parallel to the longitudinal axis of the rotor 1.

The Reed bulbs are directly fixed to the three contacts of the connector 9 by their leads. The contacts 10A, 10B, 10C present a longitudinal axis that is roughly parallel to that of the Reed bulbs and include extensions to the leads of the latter. These extensions are particularly visible in FIG. 3E. The central contact 10B is prolonged in the form of a T, each end of which is linked to a lead of each Reed bulb. The other two contacts 10A, 10C are respectively connected to the other lead of each Reed bulb. Preferably, its connections between contacts and leads are made by soldering.

The connector body 4 is fixed to the stator 2 by a rail and slideway arrangement roughly parallel to the longitudinal axis of the rotor and seen in cross-section in FIG. 4. More specifically, the connector body 4 comprises on each of its sides a flange 11A, 11B that fits into a corresponding rail arranged on the stator 1, when the connector body is fitted on the latter.

Furthermore, as already seen, the connector body 4 comprises at its end opposite to the contacts, a device for snap-fitting on the stator 1. This device comprises an orifice 12 provided on a flange 13 positioned at the end of the connector body 4 facing the key entry 3. An associated elastic tab formed on the stator 1 snap-fits into this orifice 12 at the end of travel of the flanges 11A, 11B in their respective rails.

In the fitted position, the Reed bulbs are positioned so as to straddle the front side of the cam 9 supporting the magnet 6. They are also advantageously positioned with their transverse plane of symmetry roughly in one and the same plane, also containing the magnet 6. Thus, the magnetic field induced by the magnet stresses them in the vicinity of this transverse plane of symmetry, at the point where their sensitivity is maximum.

The operation of the switch according to the positions of the rotor 2 is illustrated in FIGS. 5A to 5C.

According to the example described, the anti-theft lock can take three positions: off position represented in FIG. 5A, contact position represented in FIG. 5B, and the start position represented in FIG. 5C. It could also include an “accessories” position and in this case three Reed bulbs would be used according to the same principle.

The rotation angles of the rotor for switching from one to the other of the positions depend on the requirements of the motor car manufacturer or of national standards, and the angles represented in the figures are only examples.

In the off position, illustrated in FIG. 5A, which corresponds to the relative position of the lock and of the switch after assembly, the magnet 6 is separated from the Reed bulbs 7A, 7B, and these bulbs are both open. No electrical signal is therefore transmitted by the connector 9 to the control unit that is connected to them.

The key is turned by a first angle to bring the rotor into the contact position illustrated in FIG. 5B. The magnet 6 is then close to one of the Reed bulbs 7B which closes under the effect of the magnetic field. Two contacts 10A and 10B are then switched and transmit an electrical signal to the control unit which supplies power to the electrical equipment.

The key can be turned by a second angle to turn the rotor into the start position illustrated in FIG. 5C. During this rotation, the bulb 7B remains closed and the bulb 7A closes, ensuring the switching of the three contacts 10A to 10C. The electrical signal transmitted to the control unit starts the motor.

From this position, the key can be turned in a reverse direction to return to the position illustrated in FIG. 5B where the starter is no longer powered but the motor is on, the bulb 7A being open following the separation of the magnet 6. Then, by an additional rotation in the same direction, the key is returned to the position illustrated in FIG. 5A, in the off position where both Reed bulbs are open.

FIGS. 6A and 6B represent an embodiment variant of a switch according to the invention.

This switch differs from that described previously by the fact that the Reed bulbs 7A, 7B are linked to the contacts 10′A, 10′B, 10′C of the connector via a printed circuit card 15.

The Reed bulbs are then soldered to the card 15 which has two slots 15A and 15B into which the bulbs are fitted. The contacts are soldered close to one side of this card. Once the connections are made, the card/Reed bulbs/contacts assembly is inserted into a space formed in the housing of the switch 4′.

1. A switch for starting and stopping at least one operating unit of a motor vehicle configured to cooperate with an anti-theft lock comprising a stator and a rotor that can be rotated inside the stator and that has at least one permanent magnet secured to the rotor, said switch comprising:
at least two Reed bulbs provided with flexible leads and electrically linked by the leads to the contacts of a connector,
wherein said Reed bulbs are arranged on a connector body designed to be fixed removably to said stator in a so-called operating position.

2. The switch as claimed in claim 1, wherein the longitudinal axis of said Reed bulbs is roughly parallel to a north-south axis of said magnet, in the operating position.

3. The switch as claimed in claim 2, wherein the longitudinal axis of said Reed bulbs is roughly parallel to a longitudinal axis of the rotor, each of said Reed bulbs being arranged with a transverse plane of symmetry roughly in one and the same plane also containing the magnet in said operating position.

4. The switch as claimed in claim 1, wherein said Reed bulbs are directly fixed to said contacts of the connector by the leads.

5. The switch as claimed in claim 4, wherein said contacts include extensions to the leads of said Reed bulbs.

6. The switch as claimed in claim 1, wherein said Reed bulbs are linked to said contacts of the connector via a printed circuit card.

7. The switch as claimed in claim 1, wherein said contacts present a longitudinal axis roughly parallel to that of said Reed bulbs.

8. The switch as claimed claim 1, wherein said connector body can be fixed to the stator by a rail and slideway arrangement.

9. The switch as claimed in claim 1, wherein said rail and slideway arrangement is roughly parallel to the longitudinal axis of the rotor.

10. The switch as claimed in claim 9, wherein said connector body comprises a device for snap-fitting on the stator.

11. An anti-theft lock comprising
a stator;
a rotor that can be rotated inside the stator; and
at least one permanent magnet secured to the rotor,
wherein the anti-theft lock is fitted with a switch for starting and stopping at least one operating unit of a motor vehicle comprising:
at least two Reed bulbs provided with flexible leads and electrically linked by the leads to the contacts of a connector,
wherein said Reed bulbs are arranged on a connector body designed to be fixed removably to said stator in a so-called operating position, and
wherein said magnet is supported by the front side of a cam secured to the internal end of the rotor.

12. The lock as claimed in the claim 11, wherein said magnet is made of plasto-ferrite material and is overmolded on said cam.

13. The lock as claimed in the claim 11, wherein the longitudinal axis of said Reed bulbs is roughly parallel to a north-south axis of said magnet, in the operating position.

14. The lock as claimed in the claim 13, wherein the longitudinal axis of said Reed bulbs is roughly parallel to a longitudinal axis of the rotor, each of said Reed bulbs being arranged with a transverse plane of symmetry roughly in one and the same plane also containing the magnet in said operating position.

15. The lock as claimed in claim 11, wherein said Reed bulbs are directly fixed to said contacts of the connector by the leads.

16. The lock as claimed in claim 15, wherein said contacts include extensions to the leads of said Reed bulbs.

17. The lock as claimed in claim 11, wherein said Reed bulbs are linked to said contacts of the connector via a printed circuit card.

18. The lock as claimed in claim 11, wherein said contacts present a longitudinal axis roughly parallel to that of said Reed bulbs.

19. The lock as claimed claim 11, wherein said connector body can be fixed to the stator by a rail and slideway arrangement.

20. The lock as claimed in claim 11, wherein said rail and slideway arrangement is roughly parallel to the longitudinal axis of the rotor.
